(19) United States
(12) Patent Application Publication
(10) Pub. No.: US 2005/0102785 A1
(43) Pub. Date: May 19, 2005

(54) Cloth for cleaning rigid surfaces

(75) Inventor: Jody Keener, Cedar Rapids, IA (US)

Correspondence Address: Gerald T. Welch, Esq.;Patton Boggs, LLP, Suite 3000, 2001 Ross Avenue, Dallas, TX, 75201, US

(73) Assignee: J. Lloyd International Inc.

(21) Appl. No.: 10/714,176

(22) Filed: Nov. 14, 2003

(51) Int. Cl. G02C 13/00

(52) U.S. Cl. 15/214

(57) ABSTRACT

A cloth formed of a fabric to include ribs about visually apparent openings having sufficiently small dimensions to limit contact between a user's fingers and a rigid surface. The fabric may be substantially non-absorbent and lightweight. The ribs aid in the cleaning effectiveness of the cloth and the visually apparent openings reduce the weight of the cloth.

### BACKGROUND OF THE INVENTION

1. Technical Field of the Invention

The principles of the present invention provide for a cloth for cleaning rigid surfaces, and more particularly, but not by limitation, for a cloth having visually apparent openings for cleaning optically translucent surfaces.

2. Description of Related Art

Cloths or chamois for cleaning eyeglasses or jewelry 10 have been used for a long time. Many of these conventional cloths rely on liquid or moisture to aid in the cleaning process. The conventional cloths generally utilize a relatively thick fabric or material that is finely woven to provide for a cloth that has high enough stitch count to form an opaque cloth (i.e., one that has no visually apparent openings). In addition, these conventional cloths are generally smooth to the touch, which in many cases makes the cloth less effective as a glass or jewelry cleaner. Due to the configurations (e.g., thick fabric, finely woven, high stitch count), the cloth is relatively bulky and inconvenient. What is needed is a non-bulky, lightweight cloth that provides good cleaning ability.

### SUMMARY OF THE INVENTION

To overcome thse problems of conventional cloths, the principles of the present invention provide for a cloth formed of a fabric to include ribs about visually apparent openings having sufficiently small dimensions to limit contact between a user's fingers and a rigid surface. The fabric may be substantially non-absorbent and lightweight. The ribs aid in the cleaning effectiveness of the cloth and the visually apparent openings reduce the weight of the cloth.

### BRIEF DESCRIPTION OF THE DRAWINGS

For a more complete understanding of the present invention, reference is made to the following detailed description taken in conjunction with the accompanying drawings wherein:

FIG. 1 is an illustration of an exemplary cloth for cleaning surfaces according to the principles of the present invention; and

FIG. 2 is an illustration of the cloth of FIG. 1 being utilized to clean a lens of a pair of eyeglasses.

### DETAILED DESCRIPTION OF THE DRAWINGS

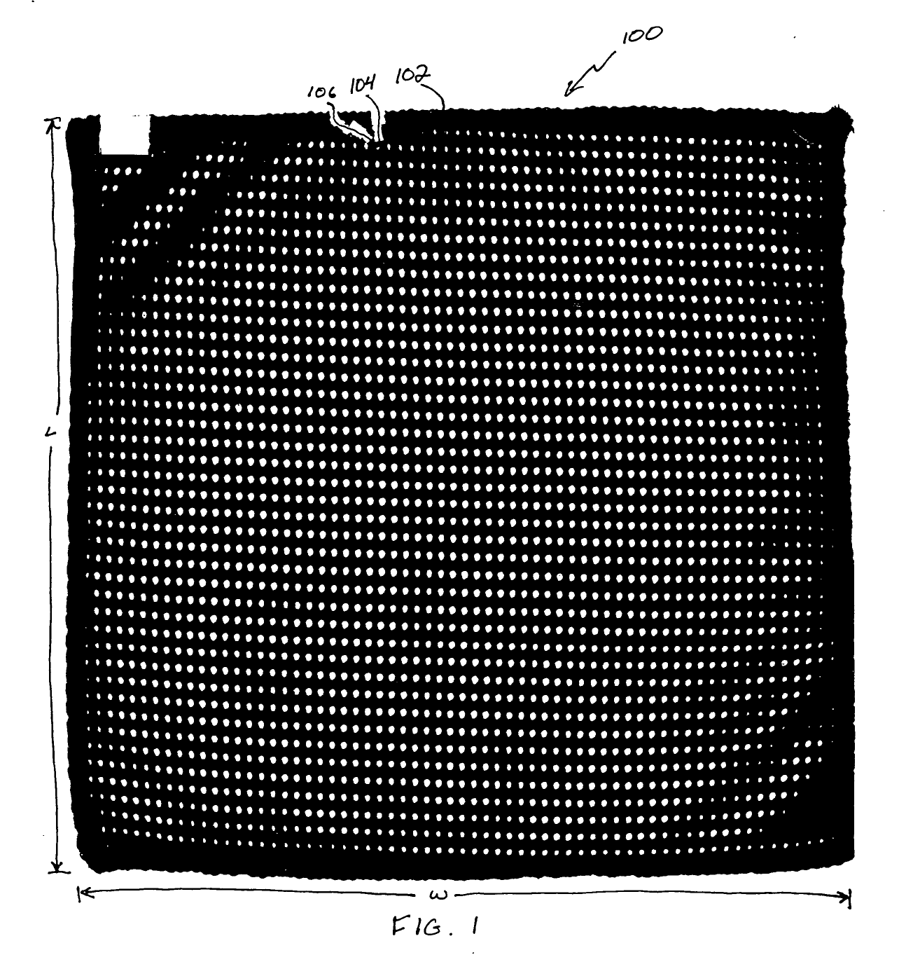

FIG. 1 is an illustration of an exemplary cloth 100 for cleaning surfaces according to the principles of the present invention. The surfaces are generally rigid, such as glass or plastic materials. The surfaces further may be translucent, such as glass (e.g., eyeglasses) or jewelry (e.g., diamonds), or alternatively non-translucent. In one embodiment, the cloth is rectangular (L×W) in shape and has a maximum dimension of eight inches to make the cloth convenient to carry and handle. The cloth 100 may be formed of a fabric 102 or material that is substantially non-absorbent and lint free. For example, the fabric 102 is polyester, nylon or any other non-absorbant, lint-free material. In another embodiment, fabric that is lint free, but has moisture absorption capability may be utilized.

As shown, the fabric 102 is woven in a configuration to include visually apparent openings 104 indicative of a fabric having a weave with a relatively low stitch count (e.g., below 50). In one embodiment, the visually apparent openings 104 should be small enough to limit contact between the user's fingers and the surface when cleaning. In one embodiment, the visually apparent openings 104 have a maximum dimension of 1/16th of an inch. By utilizing such a weave, ribs 106 or ridges are formed about the openings 104 to provide more surface area for cleaning a surface. And, the low stitch count makes the cloth much lighter and flatter (1/16th of an inch thick) when folded twice (i.e., into quarters) than conventional cloth cleaners. Of course, a cloth with smaller dimensions will weigh less and can be folded fewer times. The weaving process that may be is one as understood in the art. Alternatively, strips of fabric or other material may be configured to form the cloth 100 with visually apparent openings via stitching or other securing mechanism may be utilized.

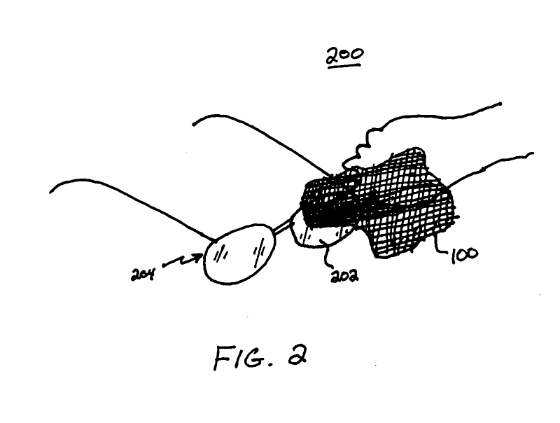

FIG. 2 is an illustration 200 of the cloth 100 of FIG. 1 being utilized to clean a lens 202 of a pair of eyeglasses 204. Because the cloth 100 is woven to include visually apparent openings of a limited size, a user can clean the eyeglass lens 202 without streaking them with oil from the user's fingers because the ribs 106 of the fabric formed about the openings provide sufficient cleaning surface while the maximum dimension of the openings limit the extent to which the fingers touch the glass surface. Because of the cloth having a maximum dimension of about eight inches, the user can manipulate the cloth easily with his hand 206, and then fold and store the cloth for future use.

Although a preferred embodiment of the method and apparatus of the present invention has been illustrated in the accompanying Drawings and described in the foregoing Detailed Description, it is understood that the invention is not limited to the embodiment disclosed, but is capable of numerous rearrangements, modifications, and substitutions without departing from the spirit of the invention as set forth and defined by the following claims.

1. A cloth for cleaning rigid surfaces, comprising:
a fabric configured with ribs formed about visually apparent openings having a sufficiently small dimension to limit contact between a user's fingers and the rigid surface.

2. The cloth of claim 1, wherein said fabric is substantially non-absorbent.

3. The cloth of claim 1, wherein said fabric is lightweight.

4. The cloth of claim 1, wherein said fabric is further configured in a rectangular shape.

5. The cloth of claim 4, wherein the rectangular shape has a maximum dimension of eight inches.

6. The cloth of claim 1, wherein the fabric further is configured in a weave.

7. The cloth of claim 6, wherein the weave has a low stitch count.

8. A method of manufacturing a cloth for cleaning rigid surfaces, comprising:
forming the cloth with a fabric to include ribs about visually apparent openings having sufficiently small dimensions to limit contact between a user's fingers and the rigid surface.

9. The method of claim 8, wherein said forming includes utilizing a fabric that is substantially non-absorbent.

10. The method of claim 8, wherein said forming includes configuring the cloth in a substantially rectangular shape.

11. The method of claim 10, wherein said forming includes configuring the substantially rectangular shape having a maximum dimension of eight inches.

12. The method of claim 8, wherein said forming includes utilizing a lightweight fabric.

13. The method of claim 8, wherein said forming produces the cloth with a low stitch count.

14. The method of claim 8, wherein said forming includes weaving the fabric.
